(19) United States
(12) Patent Application Publication
(10) Pub. No.: US 2026/0119431 A1
(43) Pub. Date: Apr. 30, 2026

(54) DYNAMIC FREQUENCY ADJUSTMENT IN MULTI-CHIPLET ARRANGEMENT

(71) Applicant: Arm Limited, Cambridge (GB)

(72) Inventors: Aniket Vinayak Bharaswadkar, Chandler, AZ (US); Deepak Goel, San Jose, CA (US)

(21) Appl. No.: 18/930,736

(22) Filed: Oct. 29, 2024

(51) Int. Cl. G06F 13/40

(52) U.S. Cl. CPC G06F 13/4004; G06F 2213/40

(57) ABSTRACT

The present disclosure relates generally to multi-processor arrangements and, more particularly, to dynamic frequency adjustments for multi-chiplet arrangements.

### BACKGROUND

### Field

The present disclosure relates generally to multi-processor arrangements and, more particularly, to dynamic frequency adjustments for multi-chiplet arrangements.

### Information

Integrated circuit devices, such as processors, for example, may be found in a wide range of electronic device types. Computing devices, for example, may include integrated circuit devices, such as processors, to process signals and/or states representative of diverse content types for a variety of purposes. Further, signal and/or state processing techniques continue to evolve. Some computing devices, for example, may include one or more Systems on a Chip (SoC)-type components comprising multi-chiplet arrangements, wherein individual chiplets may include multiple processing cores and/or other circuit types, for example.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic block diagram depicting an example processing core including multiple processing elements, in accordance with an embodiment;

FIG. 2 is a schematic block diagram depicting an example chiplet comprising a plurality of processing cores, in accordance with an embodiment;

FIG. 3 is a schematic block diagram depicting an example arrangement of chiplets including an inter-chiplet interconnect, in accordance with an embodiment;

FIG. 4 is a schematic block diagram depicting an example inter-chiplet interconnect interface for a chiplet, in accordance with an embodiment;

FIG. 5 is a schematic block diagram depicting example buffers for an example inter-chiplet interconnect interface for a chiplet, in accordance with an embodiment;

FIG. 6 is a flow diagram depicting an example process for adjusting a signal packet generation and/or transmission rate at a chiplet of a multi-chiplet arrangement, in accordance with an embodiment;

FIG. 7 is a flow diagram depicting an example process for dynamic voltage and/or frequency scaling (DVFS) within a multi-chiplet arrangement, in accordance with an embodiment; and

FIG. 8 is a schematic diagram illustrating an embodiment of an example

### COMPUTING DEVICE

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification o one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

As mentioned above, integrated circuit devices, such as processors, for example, may be found in a wide range of electronic device types. Computing devices, for example, may include integrated circuit devices, such as processors, to process signals and/or states representative of diverse content types for a variety of purposes. Further, signal and/or state processing techniques continue to evolve. Some computing devices, for example, may include one or more Systems on a Chip (SoC)-type components comprising multi-chiplet arrangements, wherein individual chiplets may include multiple processing cores and/or other circuit types.

For example, neural networks may find increasing utility in a range of applications including speech recognition, computing device vision applications (e.g., facial recognition, handwriting recognition, etc.), and/or natural language processing, to name but a few examples. Relatively large neural network models, for example, may utilize considerable memory storage space, memory interface bandwidth, and/or computing resources, for example. To perform neural network inference operations, for example, some computing devices may incorporate multiple processing units, such as multi-chiplet arrangements, for example. As discussed more fully below, implementing multi-chiplet arrangements may pose particular challenges with respect to efficient and/or accurate communication of signals and/or signal packets (e.g., data) between and/or among chiplets, for example, in an environment of dynamically variable workload circumstances, variable thermal conditions, etc.

To address, at least in part, the example challenges and/or considerations mentioned above, embodiments may be directed, at least in part, to manage communication of data (e.g., signals and/or signal packets) between various chiplets in a multi-chiplet arrangement without dropping any data packets (i.e., lossless) while allowing individual chiplets of a multi-chiplet arrangement to vary their respective clock frequencies (e.g., for thermal, workload, and/or power management purposes) independent of clock frequencies for other chiplets in a multi-chiplet arrangement, for example.

In embodiments, an apparatus may comprise a first chiplet comprising a first plurality of processing elements interconnected via a first intra-chiplet interconnect, a second chiplet comprising a second plurality of processing elements interconnected via a second intra-chiplet interconnect, and an inter-chiplet interconnect to electronically couple at least the first chiplet to at least the second chiplet, wherein the first chiplet comprises one or more storage buffers having a capacity sufficient to losslessly receive a plurality of signal packets from the second chiplet for an allowable difference in a first clock frequency for the first intra-chiplet interconnect and a second clock frequency for the second intra-chiplet interconnect. In implementations, at least one of the first clock frequency and the second clock frequency may be independently adjustable. Also, in implementations, the inter-chiplet interconnect may operate at a fixed clock frequency and/or with fixed data flow characteristics, for example.

In implementations, an apparatus may further comprise a plurality of chiplets including the first and second chiplets, wherein respective chiplets of the plurality of chiplets comprise multiple processing elements interconnected via at least one of a mesh-type, star-type, or ring-type intra-chiplet interconnect. In implementations, individual intra-chiplet interconnects for the respective plurality of chiplets may operate at a voltage and/or a frequency selected independent of any other intra-chiplet interconnect for any other chiplet of the plurality of chiplets. In implementations, individual chiplets of the plurality of chiplets may be bi-directionally interconnected with at least one other chiplet of the plurality of chiplets via a plurality of links of the inter-chiplet interconnect, wherein the plurality of links may be individually capable of transmitting and/or receiving a plurality of signal packets.

In implementations, a plurality of chiplets may respectively comprise a plurality of storage buffers corresponding to a plurality of links, wherein the plurality of storage buffers respectively have capacities sufficient to losslessly receive signal packets via the plurality of links. In implementations, for the plurality of chiplets, a plurality of storage buffers may have respective capacities implemented based, at least in part, on flit-based inter-chiplet interconnect protocol-level credit characteristics for an allowable range of operating frequencies for individual intra-chiplet interconnects for the respective plurality of chiplets.

Embodiments may include a process, comprising transmitting, from a first chiplet of a plurality of chiplets to at least a second chiplet of the plurality of chiplets, a signal and/or signal packet indicative of an intention by the first chiplet to adjust a clock frequency for a first intra-chiplet interconnect for the first chiplet, and may also include, responsive at least in part to receiving the signal and/or signal packet indicative of the intention by the first chiplet to adjust the first intra-chiplet interconnect clock frequency, adjusting, at the at least the second chiplet, a signal packet generation and/or transmission rate in accordance with the indicated intention by the first chiplet to adjust the first intra-chiplet interconnect clock frequency.

In implementations, a signal and/or signal packet indicative of an intention by a first chiplet to adjust the clock frequency for a first intra-chiplet interconnect may comprise a signal and/or signal packet representative of a throttling rate parameter for an inter-chiplet interconnect. In implementations, a process may further comprise transmitting, from the second chiplet to the first chiplet via the inter-chiplet interconnect, a plurality of signal packets, including throttling, at the second chiplet, a signal packet generation rate in accordance with the throttling rate parameter. In implementations, throttling a signal packet generation rate at the second chiplet may include the second chiplet inserting bubbles into one or more links of a plurality of links of the inter-chiplet interconnect.

In implementations, a process may further comprise, responsive at least in part to detecting a thermal parameter exceeding the specified threshold and/or responsive at least in part to an adjustment of a workload parameter, determining, at a first chiplet, an adjustment of the operating clock frequency of the intra-chiplet interconnect of the first chiplet. In implementations, an adjustment of an operating clock frequency of an intra-chiplet interconnect may comprise a reduction in the operating clock frequency.

Also, in implementations, transmitting, from the first chiplet of a plurality of chiplets to the at least the second chiplet of the plurality of chiplets, the signal and/or signal packet indicative of the intention by the first chiplet to adjust a clock frequency for the first intra-chiplet interconnect for the first chiplet may further comprise transmitting, from the first chiplet of a plurality of chiplets to the at least the second chiplet of the plurality of chiplets, one or more signals and/or signal packets indicative of a specified future point in time at which the first chiplet is to adjust the clock frequency for the first intra-chiplet interconnect. In implementations, a process may also comprise adjusting, at individual chiplets of the plurality of chiplets, including the first and second chiplets, operating clock frequencies of respective intra-chiplet interconnects for the respective plurality of chiplets responsive at least in part to the signal and/or signal packet indicative of the intention by the first chiplet to adjust a clock frequency for the first intra-chiplet interconnect and further responsive to the one or more signals and/or signal packets indicative of the specified future point in time at which the first chiplet is to adjust the clock frequency for the first intra-chiplet interconnect.

Embodiments may include an apparatus, comprising a first chiplet of a plurality of chiplets, wherein the first chiplet comprises a first plurality of processing elements interconnected via a first intra-chiplet interconnect, a second chiplet of the plurality of chiplets, wherein the second chiplet comprises a second plurality of processing elements interconnected via a second intra-chiplet interconnect, and an inter-chiplet interconnect to electronically couple at least the first chiplet to at least a second chiplet of the plurality of chiplets, wherein the first chiplet to transmit to at least the second chiplet, via one or more lanes of the inter-chiplet interconnect, a signal and/or signal packet indicative of an intention by the first chiplet to adjust a clock frequency for a first intra-chiplet interconnect for the first chiplet, and wherein the at least the second chiplet to adjust a signal packet generation and/or transmission rate in accordance with the indicated intention by the first chiplet to adjust the first intra-chiplet interconnect clock frequency.

In implementations, the signal and/or signal packet indicative of the intention by the first chiplet to adjust the clock frequency for the first intra-chiplet interconnect may comprise a signal and/or signal packet representative of a throttling rate parameter for an inter-chiplet interconnect, wherein, to transmit to the first chiplet a plurality of signal packets, the at least the second chiplet may throttle a signal packet generation rate in accordance with the throttling rate parameter. In implementations, the first chiplet may determine the adjustment of the operating clock frequency of the intra-chiplet interconnect of the first chiplet responsive at least in part to a detection of a thermal parameter exceeding the specified threshold and/or responsive at least in part to an adjustment of a workload parameter.

In implementations, the signal and/or signal packet indicative of the intention by the first chiplet to adjust the clock frequency for the first intra-chiplet interconnect may further comprise one or more signals and/or signal packets indicative of a specified future point in time at which the first chiplet is to adjust the clock frequency for the first intra-chiplet interconnect. In implementations, individual chiplets of the plurality of chiplets, including the first and second chiplets, may adjust operating clock frequencies of respective intra-chiplet interconnects responsive at least in part to the signal and/or signal packet indicative of the intention by the first chiplet to adjust a clock frequency for the first intra-chiplet interconnect and further responsive to the one or more signals and/or signal packets indicative of the specified future point in time at which the first chiplet is to adjust the clock frequency for the first intra-chiplet interconnect.

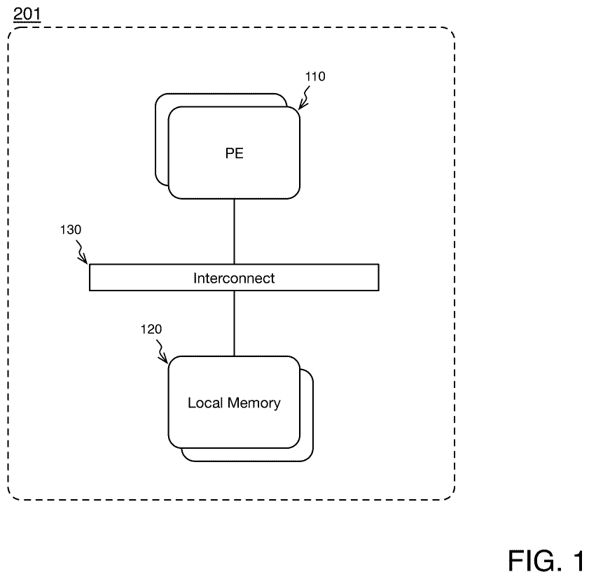

FIG. 1 is a schematic block diagram depicting an example processing core 201 including multiple processing elements, such as processing elements 110, in accordance with an embodiment. In implementations, processing cores, such as processing core 201, may include local memory, such as local memory 120, and/or may include an interconnect, such as crossbar (X-bar) interconnect 130, for example. In implementations, PEs 110 may include one or more central processing units (CPU), one or more image signal processors (ISP), one or more video processing units (VPU), one or more neural processing units (NPU), one or more vector execution units (VE), one or more convolution units (CU), and/or one or more artificial intelligence (AI) accelerators, for example. Also, processing cores, such as processing core 201, may include other circuit types, such as, for example, one or more direct memory access (DMA) controllers, one or more power management units (PMU), one or control processors, and/or one or more interconnect controllers, in implementations. Although processing core 201 is depicted as comprising particular execution units, interconnects and/or memories, for example, a wide range of arrangements, configurations, etc. are possible in a variety of implementations, and subject matter is not limited in scope in these respects.

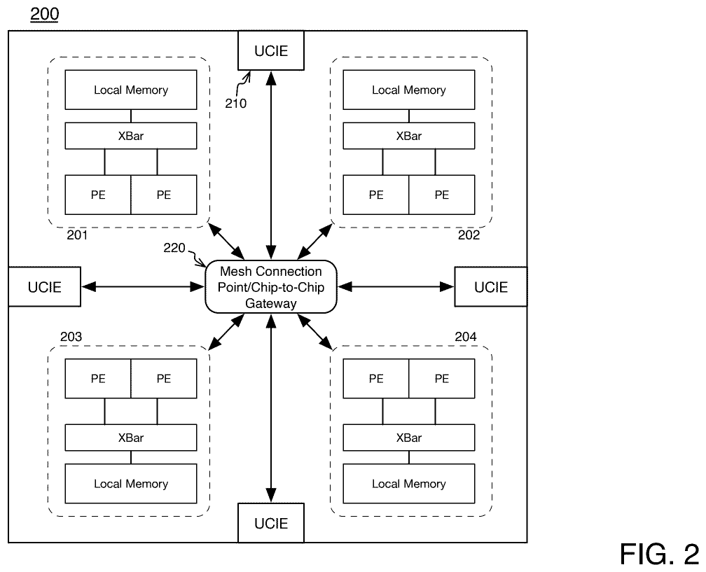

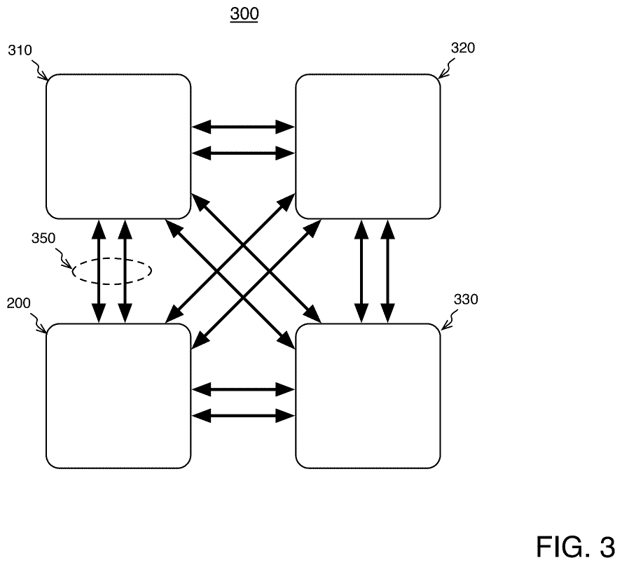

FIG. 2 is a schematic block diagram depicting an example chiplet 200, in accordance with an embodiment. In this context, “chiplet” and/or the like refers to an integrated circuit having specified functionality that is intended to be combined with other chiplets (e.g., within a particular integrated circuit package) to implement a more complex electronic component (e.g., system-on-a-chip (SoC)), See, for example, FIG. 3, discussed below.

As depicted in FIG. 2, a chiplet may include one or more processing cores and/or other circuit types. For example, chiplet 200 may comprise processing cores 201, 202, 203 and/or 204. As previously mentioned, individual processing cores, such as processing core 201, may include one or more PEs (e.g., one or more CPUs, ISPs, VPUs, NPUs, VEs, CUs, AI accelerators, etc.) and an interconnect (e.g., X-bar interconnect). As also mentioned, processing cores, such as processing cores 201, 202, 203 and/or 204, may include local memories and/or other circuit types (e.g., DMA controllers, PMUs, control processors, interconnect controllers, etc.). Further, in implementations, chiplets, such as chiplet 200, may include one or more control processors, for example.

In implementations, a chiplet, such as chiplet 200, may comprise an intra-chiplet interconnect 220 to facilitate communication of signals and/or signal packets (e.g., data) among the various processing cores (e.g., cores 201, 202, 203, and/or 204) and/or other circuit types within chiplet 200. In implementations, intra-chiplet interconnect 220 may comprise a mesh-type interconnect, although subject matter is not limited in scope in these respects. For example, other implementations may include ring-type and/or star-type interconnects, although, again, subject matter is not limited in this respect.

Also depicted in FIG. 2 are inter-chiplet interconnect interface circuits 210. In implementations, inter-chiplet interconnect interface circuits 210 may facilitate communication (e.g., data) between chiplet 200 and one or more other chiplets in a multi-chiplet arrangement, such as depicted in FIG. 3 (discussed below), for example. In implementations, inter-chiplet interconnect interface circuits 210 may substantially compliant and/or substantially compatible with a Universal Chiplet Interconnect Express^{TM} (UCIe^{TM}) specification.

In implementations, intra-chiplet interconnect 220 may comprise a mesh connection point and/or chip-to-chip gateway. For example, intra-chiplet interconnect 220 may, as a chip-to-chip gateway, facilitate communication (e.g., data) between and/or among processing cores 201, 202, 203, and/or 204 and/or other circuit types within chiplet 200. In implementations, intra-chiplet interconnect 220 may also, as a mesh connection point, facilitate communication between one or more of processing cores 201, 202, 203, and/or 204, for example, and inter-chiplet interconnect interface circuits 210. In turn, as mentioned, inter-chiplet interconnect interface circuits 210 may facilitate communication between chiplet 200 and one or more other chiplets in a multi-chiplet arrangement, such as depicted in FIG. 3.

Although chiplet 200 is depicted and/or discussed as comprising a particular arrangement of processing cores, other circuit types, and/or intra-chiplet interconnect, subject matter is not limited in scope in these respects. Rather, for example, a wide range of arrangements, configurations, etc. are possible in a variety of implementations.

FIG. 3 is a schematic block diagram depicting an example arrangement 300 of chiplets including an inter-chiplet interconnect 350, in accordance with an embodiment. In implementations, multi-chiplet arrangement 300 may comprise a plurality of chiplets, such as, for example, chiplet 200, chiplet 310, chiplet 320, and/or chiplet 330. Although multi-chiplet arrangement 300 is depicted and/or described as comprising four chiplets, other implementations may comprise any number of chiplets and/or any of a wide range of chiplet types, and subject matter is not limited in scope in these respects.

In implementations, chiplets of a multi-chiplet arrangement, such as multi-chiplet arrangement 300, may be electronically coupled one to another by way of an inter-chiplet interconnect, such as inter-chiplet interconnect 350. In implementations, an individual chiplet, such as chiplet 200, may communicate with one or more other chiplets of an arrangement by way of an inter-chiplet interconnect. For example, as depicted in FIG. 3, chiplet 200 may transmit data to and/or receive data from any of chiplets 310, 320, and/or 330. As alluded to previously, inter-chiplet interconnect 350 may be substantially compliant and/or substantially compatible with a UCIe™ specification, although subject matter is not limited in scope in this respect.

In implementations, inter-chiplet interconnect 350 may comprise one or more links and/or lanes (as utilized herein in this context, “links” and “lanes” may be used interchangeably) coupled between respective chiplets. For example, multi-chiplet arrangement 300 may comprise two bi-directional links between respective chiplets, such as between chiplet 200 and chiplet 310, between chiplet 200 and chiplet 320, and/or between chiplet 200 and chiplet 330. However, although two links are depicted and/or described between respective chiplets, other implementations may include any number of links (e.g., four links, eight links, etc.). In implementations, individual links of a plurality of links of inter-chiplet interconnect 350 may be configured to transmit and/or receive a plurality of signal packets.

In some circumstances, SoC (e.g., multi-chip arrangement 300) functionality may be distributed across multiple chiplets, such as across chiplets 200, 310, 320, and/or 330. In implementations, individual chiplets may have an ability to determine and/or control their respective thermal management and/or dynamic voltage and/or frequency scaling (DVFS) setpoints. Further, as discussed above, individual chiplets may include intra-chiplet interconnects (e.g., mesh-type, ring-type, and/or star-type) to facilitate communication among multiple processing cores and/or other circuit types. In some circumstances, such as for thermal and/or power management purposes, for example, it may be advantageous and/or beneficial for individual chiplets to independently adjust (e.g., scale) their respective intra-chiplet interconnect clock frequencies. In implementations, individual intra-chiplet interconnects for the respective chiplets may operate at a voltage and/or a frequency selected independent of any other intra-chiplet interconnect for any other chiplet. However, these characteristics, features, etc. may pose challenges with respect to avoiding system downtime and/or with respect to avoiding data loss (e.g., dropping data packets) over the links of inter-chiplet interconnect 350 as different chiplets are operating their respective intra-chiplet interconnects at difference clock frequencies, for example.

To address the challenges posed by allowing individual chiplets to independently adjust and/or scale the clock frequencies for their respective intra-chiplet interconnects (e.g., intra-chiplet interconnect 220 of chiplet 200), several example approaches are discussed below. In one example approach, buffers may be designed and/or implemented with particular characteristics in mind at the various chiplets to accommodate an allowable difference in clock frequencies for the respective chiplets, for example. In another example approach, a first chiplet (e.g., chiplet 200) may signal to at least a second chiplet (e.g., chiplet 310) an intention to adjust a clock frequency for the intra-chiplet interconnect for the first chiplet. In this example approach, at least the second chiplet may respond to the signaled intention to adjust the clock frequency for the intra-chiplet interconnect for the first chiplet by throttling signal packet generation for signal packets intended for the first chiplet to ensure that signal packets are not transmitted at a rate greater than what the first chiplet can handle in a lossless manner, for example. In yet another example approach, a first chiplet may signal to other chiplets in a multi-chiplet arrangement that the first chiplet will adjust the clock frequency for the intra-chiplet interconnect for the first chiplet and will further indicate a particular time at which the adjustment is to occur. For this example approach, the various chiplets in the multi-chiplet arrangement may, at the indicated point in time, concurrently and/or simultaneously adjust the clock frequencies for their respective intra-chiplet interconnects to match the adjustment in clock frequency signaled by the first chiplet, for example. These example approaches are discussed in more detail below.

In implementations, inter-chiplet interconnect 350 may operate at a fixed clock frequency, although subject matter is not limited in scope in this respect. Thus, for one or more example approaches discussed herein, one or more chiplets 200, 310, 320, and/or 330, for example, may adjust clock frequencies for their respective intra-chiplet interconnects while a clock frequency for inter-chiplet interconnect 350 may remain constant. Also, in implementations, inter-chiplet interconnect 350 may comprise one or more relatively lighter-weight (e.g., in terms of features and/or functionality) links that may not include capabilities to adjust data flow characteristics (e.g., clock frequency, signal packet transmission rate, etc.). That is, for example, inter-chiplet interconnect 350 may operate at a fixed clock frequency with fixed data flow characteristics, in implementations.

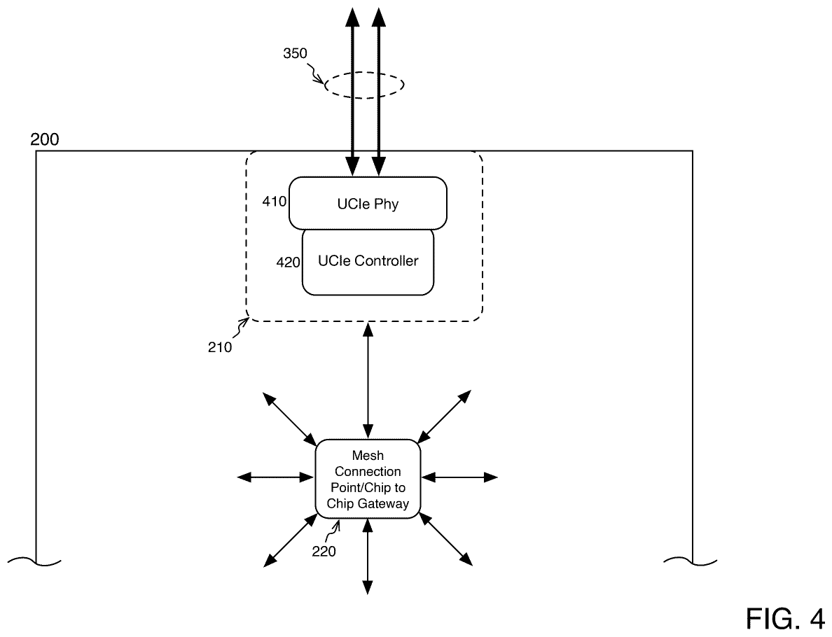

FIG. 4 is a schematic block diagram depicting an example inter-chiplet interconnect interface, such as inter-chiplet interconnect interface circuits 210, for a chiplet, such as chiplet 200, in accordance with an embodiment. As mentioned, in one or more implementations, inter-chiplet interconnect 350 may be substantially compliant with and/or substantially compatible with a UCIe specification, at least in part. Of course, other implementations may include other types of inter-chiplet interconnects, as alluded to previously.

In implementations, inter-chiplet interconnect interface circuits 210 may facilitate communication of signals and/or signal packets (e.g., data) between intra-chiplet interconnect 220 (e.g., mesh connection point/chip-to-chip gateway) and inter-chiplet interconnect 350 (e.g., UCIe interconnect). In implementations, inter-chiplet interconnect interface circuits 210 may be logically and/or physically partitioned into various layers of a protocol stack. For example, in implementations, inter-chiplet interconnect interface circuits 210 may include circuitry 410 to implement a physical layer substantially compliant and/or compatible with a UCIe specification (e.g., UCIe Phy). Also, for example, in implementations, inter-chiplet interconnect interface circuits 210 may include circuitry 420 to implement a protocol layer substantially compliant and/or compatible with a UCIe specification (e.g., UCIe Controller).

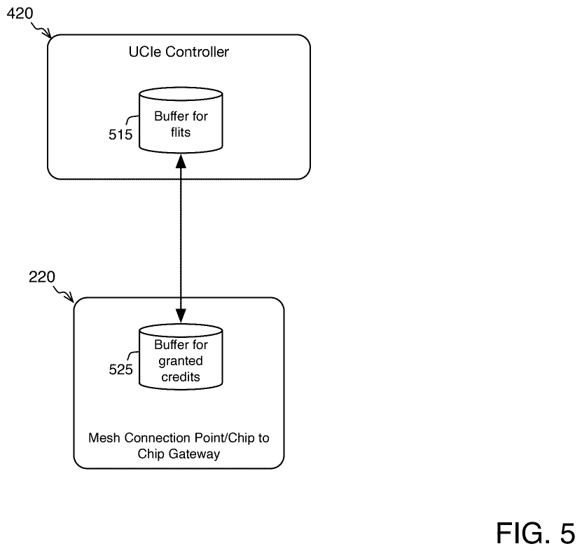

As alluded to previously, to address, at least in part, challenges posed by allowing individual chiplets to independently adjust and/or scale clock frequencies for their respective intra-chiplet interconnects, one approach may include buffers that may be designed and/or implemented with particular characteristics in mind at the various chiplets to accommodate an allowable difference in clock frequencies for the respective chiplets, for example. FIG. 5 is a schematic block diagram depicting example buffers for an example inter-chiplet interconnect interface for a chiplet, in accordance with an embodiment.

In implementations, signals and/or signal packets, such as may be communicated between and/or among chiplets via inter-chiplet interconnect 350, may be partitioned into smaller units of uniform size referred to as “flits.” In an implementation, signal packets may be substantially compliant and/or compatible with an Advanced Microcontroller Bus Architecture (AMBA) protocol specification published by Arm Limited (e.g., AMBA 5 CHI Issue D, August 2019), although claimed subject matter is not limited in scope in this respect.

Further, in an implementation, a “credit” system may be implemented to arbitrate transmission resources. For example, for transmission of flits from a first chiplet (e.g., chiplet 310) to a second chiplet (e.g., chiplet 200), the second chiplet (e.g., downstream chiplet) may communicate to the first chiplet (e.g., upstream chiplet) one or more signals and/or signal packets representative of an amount of vacancies in an input buffer of the second chiplet. Further, in an implementation, an upstream chiplet, such as the first chiplet for the current example, may transmit one or more flits to a downstream chiplet, such as the second chiplet in the current example, responsive to an indication from the upstream chiplet of sufficient vacancy in an input buffer of the downstream chiplet. Such communication may comprise transmission of a “credit” parameter from a downstream chiplet to an upstream chiplet, wherein the credit parameter may comprise one or more signals and/or states representative of an amount of vacancy within a relevant input buffer of the downstream chiplet, for example. In an implementation, such credit parameters may be updated regularly to avoid incurrence of undue delay.

For the example depicted in FIG. 5, UCIe controller 420, as part of inter-chiplet interconnect interface circuits 210 of chiplet 200, for example, may include a buffer 515 to store flits received from one or more other chiplets (e.g., chiplet 310) of multi-chiplet arrangement 300 via inter-chiplet interconnect 350. In implementations, to address, at least in part, the challenges previously identified, flit buffer 515 of chiplet 200, for example, may be designed and/or implemented to have a capacity sufficient to losslessly receive signal packets (e.g., flits) from at least a second chiplet, such as chiplet 310, for an allowable difference in a first clock frequency for intra-chiplet interconnect 220 of chiplet 200 and a second clock frequency for an intra-chiplet interconnect for at least the second chiplet (e.g., chiplet 310). In implementations, by “right sizing” buffer 515, lossless communication of signal packets (e.g., flits) via inter-chiplet 350 from at least chiplet 310, for example, to chiplet 200, for example, may be ensured regardless of any allowable difference in clock frequencies for chiplet 310 and chiplet 200, for example.

In implementations, a capacity for buffer 515 of chiplet 200, for example, may be designed and/or implemented based at least in part on an inter-chiplet interconnect protocol-level credit characteristic for an allowable range of clock frequencies for respective chiplets of multi-chiplet arrangement 300. For example, buffer 515 may be implemented to have a capacity sufficient to store a number of flits indicated by credits granted by chiplet 200, for example, to chiplet 310, for example. Also, because intra-chiplet interconnect 220 may operate at a difference clock frequency than that of inter-chiplet interconnect 350, buffer 515 may not empty to buffer 525 of intra-chiplet interconnect 220 at the same rate as might otherwise be the case if intra-chiplet interconnect 220 did not have a variable and/or adjustable clock frequency. Therefore, in implementations, the capacity for buffer 515 may be designed and/or implemented to account for an allowable difference in clock frequencies, such as between chiplets of multi-chiplet arrangement 300 and/or between inter-chiplet interconnect 350 and intra-chiplet interconnect 220, for example. For at least these reasons, buffers 515 and 525 may differ in capacity in some implementations even though they are both intended to temporarily store the same signal packets (e.g., flits).

In other implementations, buffer 515 may have a capacity that is equal to the capacity of buffer 525 so that any outstanding granted credits may be used by chiplet 310, for example, to deliver flits to chiplet 200, for example. In implementations, a number of flits received, such as at chiplet 200, may not be greater than what buffer 525 can handle in terms of capacity, for example. Thus, in implementations, intra-chiplet interconnect 220 of chiplet 200, for example, may operate at a reduced clock frequency as compared with a clock frequency of inter-chiplet interconnect 350 without dropping data packets (e.g., flits). For example, intra-chiplet interconnect 220 of chiplet 200 may reduce its clock frequency down to as far as to 0 Hz and may subsequently increase the clock frequency back up to some other rate (e.g., up to 2 GHz to match inter-chiplet interconnect 350) without ever compromising data integrity (i.e., without dropping data).

A potential advantage of the example approach discussed above is that it may allow various chiplets within a multi-chiplet arrangement, such as arrangement 300, to run at different intra-chiplet interconnect frequencies indefinitely while maintaining integrity of signal packet communications, for example.

As previously mentioned, another approach to addressing, at least in part, challenges posed by allowing individual chiplets to independently adjust and/or scale clock frequencies for their respective intra-chiplet interconnects may include a first chiplet, such as chiplet 200, signaling to at least a second chiplet, such as chiplet 310, an intention to adjust a clock frequency for the intra-chiplet interconnect for the first chiplet. For example, chiplet 200 may signal to chiplet 310 an intention to adjust a clock frequency for intra-chiplet interconnect 220. In implementations, chiplet 310, for example, may respond to the signaled intention to adjust the clock frequency for intra-chiplet interconnect 220 for chiplet 200 by throttling signal packet generation for signal packets intended for chiplet 200 to ensure that signal packets are not transmitted at a rate greater than what chiplet 200 can handle in a lossless manner, for example.

For example, chiplet 200 may detect a thermal condition exceeding a specified threshold and/or may anticipate a different workload, for example, and in response may determine to adjust (e.g., reduce) a clock frequency for at least some circuits of chiplet 200, including intra-chiplet interconnect 220. In implementations, chiplet 200 may transmit a signal or signal packet to one or more chiplets, such as chiplet 310, chiplet 320, and/or chiplet 330, to indicate an intention to adjust the clock frequency for intra-chiplet interconnect 220 at chiplet 200. In implementations, the signal transmitted by chiplet 200, for example, may indicate a particular clock frequency and/or may indicate a duty rate for transmitted signal packets (e.g., flits). For example, if chiplet 200 determines to reduce a clock frequency for intra-chiplet interconnect 220 from 2 GHz to 1 GHz and if link partner chiplet 310, for example, is operating its intra-chiplet interconnect at 2 GHz, a control processor of chiplet 200 may transmit a signal packet to chiplet 310 (e.g., to chiplet 310 intra-chiplet interconnect logic) to throttle signal packet generation to a 50% rate. In implementations, signal packet throttling may be accomplished via insertion of bubbles into one or more links of inter-chiplet interconnect 350. In this manner, it may be ensured that chiplet 310 may not generate signal packets at a rate greater than chiplet 200 may receive, thus helping to ensure operation of the one or more links of inter-chiplet interconnect 350 in a lossless manner (e.g., preventing dropped data packets).

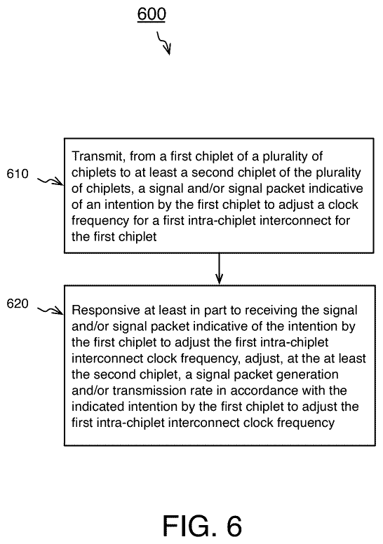

In general, for one or more implementations, a chiplet (e.g., chiplet 200) that has knowledge of an impending dynamic frequency change on its intra-chiplet interconnect (e.g., intra-chiplet 220) may communicate a throttling rate parameter to intra-chiplet interconnect logic for at least one other inter-chiplet interconnect link partner (e.g., chiplet 310). FIG. 6 shows a flow diagram depicting such an example process. In implementations, process 600 may include operations that may be performed in conjunction with example multi-chiplet arrangement 300, for example. It should be noted that content acquired or produced, such as, for example, input signals, output signals, operations, results, etc. associated with example process 600 may be represented via one or more digital signals and/or signal packets. It should also be appreciated that even though one or more operations are illustrated or described concurrently or with respect to a certain sequence, other sequences or concurrent operations may be employed. In addition, although the description herein references particular aspects and/or features illustrated in certain other figures, one or more operations may be performed with other aspects and/or features.

In implementations, example process 600 may include transmission from a first chiplet (e.g., chiplet 200) to at least a second chiplet (e.g., one or more of chiplets 310, 320, and/or 330) of a signal and/or signal packet indicative of an intention by the first chiplet (e.g., chiplet 200) to adjust a clock frequency for a first intra-chiplet interconnect (e.g., intra-chiplet interconnect 220), as indicated at block 610. Further, as indicated at block 620, responsive at least in part to receiving the signal and/or signal packet indicative of the intention by the first chiplet (e.g., chiplet 200) to adjust the first intra-chiplet interconnect (e.g., intra-chiplet interconnect 220) clock frequency, at least the second chiplet (e.g., one or more chiplets 310, 320, and/or 330) may adjust a signal packet generation and/or transmission rate in accordance with the indicated intention by the first chiplet to adjust the first intra-chiplet interconnect (e.g., intra-chiplet interconnect 220) clock frequency.

As with the previously discussed example approach, a potential advantage of the present example approach is that it may allow various chiplets within a multi-chiplet arrangement, such as arrangement 300, to run at different intra-chiplet interconnect frequencies indefinitely while maintaining integrity of signal packet communications, for example.

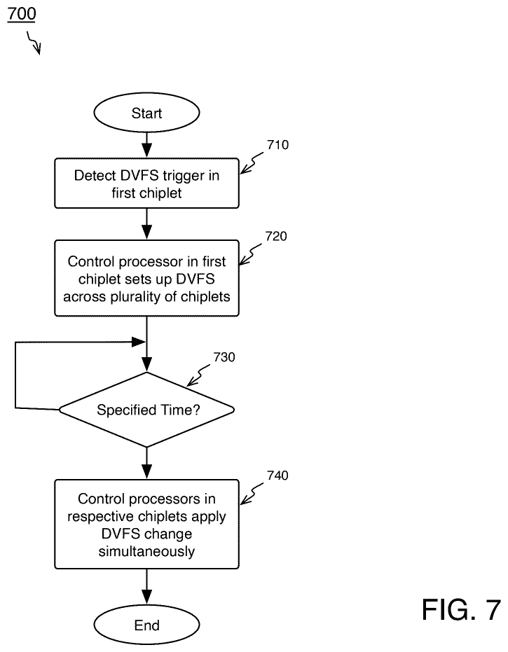

As additionally mentioned above, yet another example approach may include a first chiplet signaling to other chiplets in a multi-chiplet arrangement that the first chiplet will adjust the clock frequency for the intra-chiplet interconnect for the first chiplet and will further indicate a particular time at which the adjustment is to occur. For this example approach, the various chiplets in the multi-chiplet arrangement may, at the indicated point in time, concurrently and/or simultaneously adjust the clock frequencies for their respective intra-chiplet interconnects to match the adjustment in clock frequency signaled by the first chiplet, for example. FIG. 7 is a flow diagram depicting an example process 700 utilizing this additional approach, in accordance with an embodiment. In implementations, process 700 may include operations that may be performed in conjunction with example multi-chiplet arrangement 300, for example. It should be noted that content acquired or produced, such as, for example, input signals, output signals, operations, results, etc. associated with example process 700 may be represented via one or more digital signals and/or signal packets. It should also be appreciated that even though one or more operations are illustrated or described concurrently or with respect to a certain sequence, other sequences or concurrent operations may be employed. In addition, although the description herein references particular aspects and/or features illustrated in certain other figures, one or more operations may be performed with other aspects and/or features.

In implementations, example process 700 may include time-synchronized dynamic voltage and/or frequency scaling (e.g., adjusting clock frequency of one or more intra-chiplet interconnects for respective chiplets of multi-chiplet arrangement 300. In implementations, the present example approach may be advantageously utilized in circumstances in which intra-chiplet interconnects for multiple chiplets in an SoC (e.g., multi-chiplet arrangement 300) may change frequency and/or voltage. In implementations, example process 700 may include detecting a dynamic voltage and/or frequency scaling (e.g. DVFS) trigger in a first chiplet, such as chiplet 200, as indicated at block 710. For example, a control processor of chiplet 200 may detect a thermal condition exceeding a specified threshold, or may detect a change in a workload parameter, for example. Further, as indicated at block 720, example process 700 may include a control element, such as a control processor, of the first chiplet (e.g., chiplet 200) setting up a DVFS event across a plurality of chiplets, such as chiplets 310, 320, and/or 330, for example. In implementations, a control processor of the first chiplet (e.g., chiplet 200) may transmit a signal and/or signal packet to control processors for the other respective chiplets (e.g., chiplets 310, 320, and/or 330) of a multi-chiplet arrangement (e.g., multi-chiplet arrangement 300) to set up a point in time in the future when the various chiplets are to apply the specified DVFS event. In implementations, a particular chiplet, such as chiplet 200, may comprise a primary chiplet for a multi-chiplet arrangement, such as multi-chiplet arrangement 300. Also, in implementations, the primary chiplet (e.g., chiplet 200) may transmit the signal and/or signal packet to the other chiplets via a control bus, such as, for example, an I2C bus.

In implementations, the various chiplets (e.g., chiplets 200, 310, 320, and/or 330) of a multi-chiplet arrangement (e.g., multi-chiplet arrangement 300) may share a common “system time”. In implementations, a control processor of a primary chiplet, such as chiplet 200, may specify a point in time for the indicated DVFS event sufficiently in the future to allow control processors of the respective chiplets to process the DVFS signal and/or signal packet and/or to prepare to apply the indicated DVFS event. As indicated at block 730, when the point in time specified for the DVFS event arrives, example process 700 moves to block 740.

As indicated at block 740, responsive at least in part to the arrival of the specified point in time, control processors for the respective chiplets of multi-chiplet arrangement 300, for example, may concurrently and/or simultaneously apply the indicated DVFS event. In implementations, the indicated DVFS event may comprise a change in clock frequency for intra-chiplet interconnects for the respective chiplets of multi-chiplet arrangement 300. From the point of view of the high-speed IO links of inter-chiplet interconnect 350, both ends of the various links between the various chiplets are still matching the rates for generating and/or receiving signal packets (e.g., flits) when the indicated DVFS event is applied. In this manner, lossless operation (e.g., no dropped data packets) of the various links of inter-chiplet 350 may be ensured, and system integrity may be preserved. One potential advantage of the present example approach is that it may not require particular hardware changes, redesign, etc. with respect to inter-chiplet interconnect 350 and/or with respect to buffer sizes, thus reducing costs associated with implementing these example features. It may be noted that this present example approach, such as depicted in FIG. 7, may not allow intra-chiplet interconnect for various respective chiplets of a multi-chiplet assembly, such as assembly 300, to run at different frequencies indefinitely, in contrast with other example approaches discussed herein.

In embodiments related to the example approaches described herein, flow control for signal packets (e.g., flits), such as to prevent data loss, for example, may be implemented without sophisticated, and therefore expensive, lower level(s) of a protocol stack for die-to-die links, such as UCIe and/or other inter-chiplet interconnect type. Thus, example embodiments and/or implementations described herein may allow for a reduction in implementation costs by using a relatively lightweight lower level link, for example.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

It is likewise appreciated that terms such as “over” and “under”,” as used herein, are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes an underlayment embodiment, as one illustration, in which, for example, orientation at various times (e.g., during fabrication or application) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioral representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

A network and/or communication protocol, such as protocols characterized substantially in accordance with the aforementioned UCIe specification, may have several layers. These layers may be referred to as a protocol stack. Various types of communications (e.g., transmissions), such as network communications and/or inter-chiplet communications, may occur across various layers. A lowest level layer in a network stack, such as the so-called physical layer, may characterize how symbols (e.g., bits and/or bytes) are communicated as one or more signals (and/or signal samples) via a physical medium (e.g., integrated circuit conductive elements, conductive traces, twisted pair copper wire, coaxial cable, fiber optic cable, wireless air interface, combinations thereof, etc.). Progressing to higher-level layers in a protocol stack, additional operations and/or features may be available via engaging in communications that are substantially compatible and/or substantially compliant with a particular protocol at these higher-level layers.

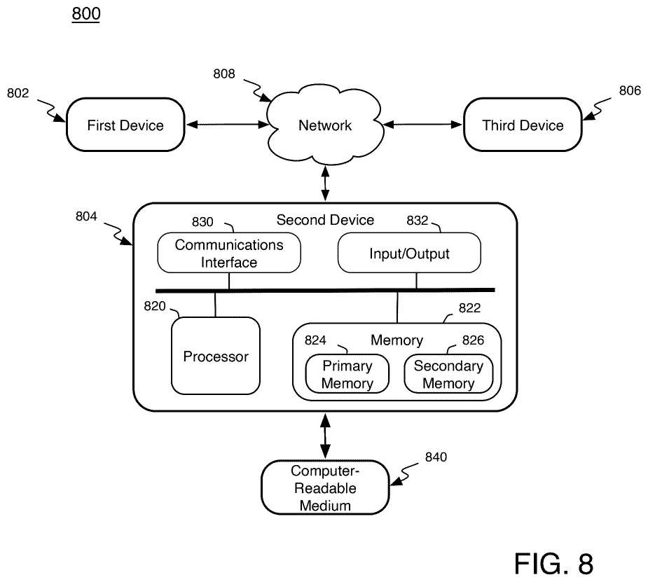

In one example embodiment, as shown in FIG. 8, a system embodiment may comprise a local network (e.g., device 804 and medium 840) and/or another type of network, such as a computing and/or communications network. For purposes of illustration, therefore, FIG. 8 shows an embodiment 800 of a system that may be employed to implement either type or both types of networks. Network 808 may comprise one or more network connections, links, processes, services, applications, and/or resources to facilitate and/or support communications, such as an exchange of communication signals, for example, between a computing device, such as 802, and another computing device, such as 806, which may, for example, comprise one or more client computing devices and/or one or more server computing device. By way of example, but not limitation, network 808 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 8 may comprise features, for example, of a client computing device and/or a server computing device, in an embodiment. It is further noted that the term computing device, in general, whether employed as a client and/or as a server, or otherwise, refers at least to a processor and a memory connected by a communication bus. Likewise, in the context of the present patent application at least, this is understood to refer to sufficient structure within the meaning of 35 USC § 112 (f) so that it is specifically intended that 35 USC § 112 (f) not be implicated by use of the term “computing device” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in figure(s) 1-7 and in the text associated at least with the foregoing figure(s) of the present patent application.

Referring now to FIG. 8, in an embodiment, first and third devices 802 and 806 may be capable of rendering a graphical user interface (GUI) for a network device and/or a computing device, for example, so that a user-operator may engage in system use. Device 804 may potentially serve a similar function in this illustration. Likewise, in FIG. 8, computing device 802 (‘first device’ in figure) may interface with computing device 804 (‘second device’ in figure), which may, for example, also comprise features of a client computing device and/or a server computing device, in an embodiment. Processor (e.g., processing device) 820 and memory 822, which may comprise primary memory 824 and secondary memory 826, may communicate by way of a communication bus 815, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, sensor content, etc. in the form of signals and/or states. Thus, a computing device, in the context of the present patent application, may comprise hardware, software, firmware, or any combination thereof (other than software per se). Computing device 804, as depicted in FIG. 8, is merely one example, and claimed subject matter is not limited in scope to this particular example.

In FIG. 8, computing device 802 may provide one or more sources of executable computer instructions in the form physical states and/or signals (e.g., stored in memory states), for example. Computing device 802 may communicate with computing device 804 by way of a network connection, such as via network 808, for example. As previously mentioned, a connection, while physical, may not necessarily be tangible. Although computing device 804 of FIG. 8 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 822 may comprise any non-transitory storage mechanism. Memory 822 may comprise, for example, primary memory 824 and secondary memory 826, additional memory circuits, mechanisms, or combinations thereof may be used. Memory 822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 822 may be utilized to store a program of executable computer instructions. For example, processor 820 may fetch executable instructions from memory and proceed to execute the fetched instructions. Memory 822 may also comprise a memory controller for accessing device readable-medium 840 that may carry and/or make accessible digital content, which may include code, and/or instructions, for example, executable by processor 820 and/or some other device, such as a controller, as one example, capable of executing computer instructions, for example. Under direction of processor 820, a non-transitory memory, such as memory cells storing physical states (e.g., memory states), comprising, for example, a program of executable computer instructions, may be executed by processor 820 and able to generate signals to be communicated via a network, for example, as previously described. Generated signals may also be stored in memory, also previously suggested. Further, in implementations, processor 820 of second device 804 may comprise one or more multi-chiplet arrangements, such as multi-chiplet arrangement 300, although subject matter is not limited in scope in this respect.

Memory 822 may store electronic files and/or electronic documents, such as relating to one or more users, and may also comprise a computer-readable medium that may carry and/or make accessible content, including code and/or instructions, for example, executable by processor 820 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Referring again to FIG. 8, processor 820 may comprise one or more circuits, such as digital circuits, to perform at least a portion of a computing procedure and/or process. By way of example, but not limitation, processor 820 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 820 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 8 also illustrates device 804 as including a component 832 operable with input/output devices, for example, so that signals and/or states may be appropriately communicated between devices, such as device 804 and an input device and/or device 804 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

Embodiments may also be described, at least in part, by the following numbered clauses:
Clause 1. An apparatus, comprising: a first chiplet comprising a first plurality of processing elements interconnected via a first intra-chiplet interconnect; a second chiplet comprising a second plurality of processing elements interconnected via a second intra-chiplet interconnect; and an inter-chiplet interconnect to electronically couple at least the first chiplet to at least the second chiplet; wherein the first chiplet comprises one or more storage buffers having a capacity sufficient to losslessly receive a plurality of signal packets from the second chiplet for an allowable difference in a first clock frequency for the first intra-chiplet interconnect and a second clock frequency for the second intra-chiplet interconnect.
Clause 2. The apparatus of clause 1, wherein at least one of the first clock frequency and the second clock frequency is independently adjustable.
Clause 3. The apparatus of any of the preceding clauses, wherein the inter-chiplet interconnect operates at a fixed clock frequency with fixed data flow characteristics.
Clause 4. The apparatus of any of the preceding clauses, further comprising: a plurality of chiplets including the first and second chiplets, wherein respective chiplets of the plurality of chiplets comprise multiple processing elements interconnected via at least one of a mesh-type, star-type, or ring-type intra-chiplet interconnect.
Clause 5. The apparatus of any of the preceding clauses, wherein individual intra-chiplet interconnects for the respective plurality of chiplets operate at a voltage and/or a frequency selected independent of any other intra-chiplet interconnect for any other chiplet of the plurality of chiplets.
Clause 6. The apparatus of any of the preceding clauses, wherein, for the inter-chiplet interconnect, individual chiplets of the plurality of chiplets are bi-directionally interconnected with at least one other chiplet of the plurality of chiplets via a plurality of links, wherein the plurality of links are individually capable of transmitting and/or receiving a plurality of signal packets.
Clause 7. The apparatus of any of the preceding clauses, wherein the plurality of chiplets respectively comprise a plurality of storage buffers corresponding to the plurality of links, wherein the plurality of storage buffers respectively have capacities sufficient to losslessly receive signal packets via the plurality of links.
Clause 8. The apparatus of any of the preceding clauses, wherein, for the plurality of chiplets, the plurality of storage buffers have respective capacities implemented based, at least in part, on flit-based inter-chiplet interconnect protocol-level credit characteristics for an allowable range of operating frequencies for individual intra-chiplet interconnects for the respective plurality of chiplets.
Clause 9. A method, comprising: transmitting, from a first chiplet of a plurality of chiplets to at least a second chiplet of the plurality of chiplets, a signal and/or signal packet indicative of an intention by the first chiplet to adjust a clock frequency for a first intra-chiplet interconnect for the first chiplet; and responsive at least in part to receiving the signal and/or signal packet indicative of the intention by the first chiplet to adjust the first intra-chiplet interconnect clock frequency, adjusting, at the at least the second chiplet, a signal packet generation and/or transmission rate in accordance with the indicated intention by the first chiplet to adjust the first intra-chiplet interconnect clock frequency.
Clause 10. The method of clause 9, wherein the signal and/or signal packet indicative of the intention by the first chiplet to adjust the clock frequency for the first intra-chiplet interconnect comprises a signal and/or signal packet representative of a throttling rate parameter for an inter-chiplet interconnect, the method further comprising transmitting, from the second chiplet to the first chiplet via the inter-chiplet interconnect, a plurality of signal packets, including throttling, at the second chiplet, a signal packet generation rate in accordance with the throttling rate parameter.
Clause 11. The method of any of clauses 9-10, wherein the throttling the signal packet generation rate at the second chiplet includes the second chiplet inserting bubbles into one or more links of a plurality of links of the inter-chiplet interconnect.
Clause 12. The method of any of clauses 9-11, further comprising: responsive at least in part to detecting a thermal parameter exceeding the specified threshold and/or responsive at least in part to an adjustment of a workload parameter, determining, at the first chiplet, the adjustment of the operating clock frequency of the intra-chiplet interconnect of the first chiplet.
Clause 13. The method of any of clauses 9-12, wherein the adjustment of the operating clock frequency of the intra-chiplet interconnect comprises a reduction in the operating clock frequency.
Clause 14. The method of any of clauses 9-13, wherein the transmitting, from the first chiplet of a plurality of chiplets to the at least the second chiplet of the plurality of chiplets, the signal and/or signal packet indicative of the intention by the first chiplet to adjust a clock frequency for the first intra-chiplet interconnect for the first chiplet further comprises transmitting, from the first chiplet of a plurality of chiplets to the at least the second chiplet of the plurality of chiplets, one or more signals and/or signal packets indicative of a specified future point in time at which the first chiplet is to adjust the clock frequency for the first intra-chiplet interconnect.
Clause 15. The method of any of clauses 9-14, further comprising adjusting, at individual chiplets of the plurality of chiplets, including the first and second chiplets, operating clock frequencies of respective intra-chiplet interconnects for the respective plurality of chiplets responsive at least in part to the signal and/or signal packet indicative of the intention by the first chiplet to adjust a clock frequency for the first intra-chiplet interconnect and further responsive to the one or more signals and/or signal packets indicative of the specified future point in time at which the first chiplet is to adjust the clock frequency for the first intra-chiplet interconnect.
Clause 16. An apparatus, comprising: a first chiplet of a plurality of chiplets, wherein the first chiplet comprises a first plurality of processing elements interconnected via a first intra-chiplet interconnect; a second chiplet of the plurality of chiplets, wherein the second chiplet comprises a second plurality of processing elements interconnected via a second intra-chiplet interconnect; and an inter-chiplet interconnect to electronically couple at least the first chiplet to at least a second chiplet of the plurality of chiplets; wherein the first chiplet to transmit to at least the second chiplet, via one or more lanes of the inter-chiplet interconnect, a signal and/or signal packet indicative of an intention by the first chiplet to adjust a clock frequency for a first intra-chiplet interconnect for the first chiplet; and wherein the at least the second chiplet to adjust a signal packet generation and/or transmission rate in accordance with the indicated intention by the first chiplet to adjust the first intra-chiplet interconnect clock frequency.
Clause 17. The apparatus of clause 16, wherein the signal and/or signal packet indicative of the intention by the first chiplet to adjust the clock frequency for the first intra-chiplet interconnect comprises a signal and/or signal packet representative of a throttling rate parameter for an inter-chiplet interconnect, wherein, to transmit to the first chiplet a plurality of signal packets, the at least the second chiplet to throttle a signal packet generation rate in accordance with the throttling rate parameter.
Clause 18. The apparatus of any of clauses 16-17, wherein the first chiplet to determine the adjustment of the operating clock frequency of the intra-chiplet interconnect of the first chiplet responsive at least in part to a detection of a thermal parameter exceeding the specified threshold and/or responsive at least in part to an adjustment of a workload parameter.
Clause 19. The apparatus of any of clauses 16-18, wherein the signal and/or signal packet indicative of the intention by the first chiplet to adjust the clock frequency for the first intra-chiplet interconnect further comprises one or more signals and/or signal packets indicative of a specified future point in time at which the first chiplet is to adjust the clock frequency for the first intra-chiplet interconnect.
Clause 20. The apparatus of any of clauses 16-19, wherein individual chiplets of the plurality of chiplets, including the first and second chiplets, are to adjust operating clock frequencies of respective intra-chiplet interconnects responsive at least in part to the signal and/or signal packet indicative of the intention by the first chiplet to adjust a clock frequency for the first intra-chiplet interconnect and further responsive to the one or more signals and/or signal packets indicative of the specified future point in time at which the first chiplet is to adjust the clock frequency for the first intra-chiplet interconnect.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. An apparatus, comprising:
a first chiplet comprising a first plurality of processing elements interconnected via a first intra-chiplet interconnect;
a second chiplet comprising a second plurality of processing elements interconnected via a second intra-chiplet interconnect; and
an inter-chiplet interconnect to electronically couple at least the first chiplet to at least the second chiplet;
wherein the first chiplet comprises one or more storage buffers having a capacity sufficient to losslessly receive a plurality of signal packets from the second chiplet for an allowable difference in a first clock frequency for the first intra-chiplet interconnect and a second clock frequency for the second intra-chiplet interconnect.

2. The apparatus of claim 1, wherein at least one of the first clock frequency and the second clock frequency is independently adjustable.

3. The apparatus of claim 2, wherein the inter-chiplet interconnect operates at a fixed clock frequency with fixed data flow characteristics.

4. The apparatus of claim 1, further comprising:
a plurality of chiplets including the first and second chiplets, wherein respective chiplets of the plurality of chiplets comprise multiple processing elements interconnected via at least one of a mesh-type, star-type, or ring-type intra-chiplet interconnect.

5. The apparatus of claim 4, wherein individual intra-chiplet interconnects for the respective plurality of chiplets operate at a voltage and/or a frequency selected independent of any other intra-chiplet interconnect for any other chiplet of the plurality of chiplets.

6. The apparatus of claim 5, wherein, for the inter-chiplet interconnect, individual chiplets of the plurality of chiplets are bi-directionally interconnected with at least one other chiplet of the plurality of chiplets via a plurality of links, wherein the plurality of links are individually capable of transmitting and/or receiving a plurality of signal packets.

7. The apparatus of claim 6, wherein the plurality of chiplets respectively comprise a plurality of storage buffers corresponding to the plurality of links, wherein the plurality of storage buffers respectively have capacities sufficient to losslessly receive signal packets via the plurality of links.

8. The apparatus of claim 7, wherein, for the plurality of chiplets, the plurality of storage buffers have respective capacities implemented based, at least in part, on flit-based inter-chiplet interconnect protocol-level credit characteristics for an allowable range of operating frequencies for individual intra-chiplet interconnects for the respective plurality of chiplets.

9. A method, comprising:
transmitting, from a first chiplet of a plurality of chiplets to at least a second chiplet of the plurality of chiplets, a signal and/or signal packet indicative of an intention by the first chiplet to adjust a clock frequency for a first intra-chiplet interconnect for the first chiplet; and
responsive at least in part to receiving the signal and/or signal packet indicative of the intention by the first chiplet to adjust the first intra-chiplet interconnect clock frequency, adjusting, at the at least the second chiplet, a signal packet generation and/or transmission rate in accordance with the indicated intention by the first chiplet to adjust the first intra-chiplet interconnect clock frequency.

10. The method of claim 9, wherein the signal and/or signal packet indicative of the intention by the first chiplet to adjust the clock frequency for the first intra-chiplet interconnect comprises a signal and/or signal packet representative of a throttling rate parameter for an inter-chiplet interconnect, the method further comprising transmitting, from the second chiplet to the first chiplet via the inter-chiplet interconnect, a plurality of signal packets, including throttling, at the second chiplet, a signal packet generation rate in accordance with the throttling rate parameter.

11. The method of claim 10, wherein the throttling the signal packet generation rate at the second chiplet includes the second chiplet inserting bubbles into one or more links of a plurality of links of the inter-chiplet interconnect.

12. The method of claim 11, further comprising:
responsive at least in part to detecting a thermal parameter exceeding the specified threshold and/or responsive at least in part to an adjustment of a workload parameter, determining, at the first chiplet, the adjustment of the operating clock frequency of the intra-chiplet interconnect of the first chiplet.

13. The method of claim 9, wherein the adjustment of the operating clock frequency of the intra-chiplet interconnect comprises a reduction in the operating clock frequency.

14. The method of claim 9, wherein the transmitting, from the first chiplet of a plurality of chiplets to the at least the second chiplet of the plurality of chiplets, the signal and/or signal packet indicative of the intention by the first chiplet to adjust a clock frequency for the first intra-chiplet interconnect for the first chiplet further comprises transmitting, from the first chiplet of a plurality of chiplets to the at least the second chiplet of the plurality of chiplets, one or more signals and/or signal packets indicative of a specified future point in time at which the first chiplet is to adjust the clock frequency for the first intra-chiplet interconnect.

15. The method of claim 14, further comprising adjusting, at individual chiplets of the plurality of chiplets, including the first and second chiplets, operating clock frequencies of respective intra-chiplet interconnects for the respective plurality of chiplets responsive at least in part to the signal and/or signal packet indicative of the intention by the first chiplet to adjust a clock frequency for the first intra-chiplet interconnect and further responsive to the one or more signals and/or signal packets indicative of the specified future point in time at which the first chiplet is to adjust the clock frequency for the first intra-chiplet interconnect.

16. An apparatus, comprising:
a first chiplet of a plurality of chiplets, wherein the first chiplet comprises a first plurality of processing elements interconnected via a first intra-chiplet interconnect;
a second chiplet of the plurality of chiplets, wherein the second chiplet comprises a second plurality of processing elements interconnected via a second intra-chiplet interconnect; and
an inter-chiplet interconnect to electronically couple at least the first chiplet to at least a second chiplet of the plurality of chiplets;
wherein the first chiplet to transmit to at least the second chiplet, via one or more lanes of the inter-chiplet interconnect, a signal and/or signal packet indicative of an intention by the first chiplet to adjust a clock frequency for a first intra-chiplet interconnect for the first chiplet; and
wherein the at least the second chiplet to adjust a signal packet generation and/or transmission rate in accordance with the indicated intention by the first chiplet to adjust the first intra-chiplet interconnect clock frequency.

17. The apparatus of claim 16, wherein the signal and/or signal packet indicative of the intention by the first chiplet to adjust the clock frequency for the first intra-chiplet interconnect comprises a signal and/or signal packet representative of a throttling rate parameter for an inter-chiplet interconnect, wherein, to transmit to the first chiplet a plurality of signal packets, the at least the second chiplet to throttle a signal packet generation rate in accordance with the throttling rate parameter.

18. The apparatus of claim 17, wherein the first chiplet to determine the adjustment of the operating clock frequency of the intra-chiplet interconnect of the first chiplet responsive at least in part to a detection of a thermal parameter exceeding the specified threshold and/or responsive at least in part to an adjustment of a workload parameter.

19. The apparatus of claim 16, wherein the signal and/or signal packet indicative of the intention by the first chiplet to adjust the clock frequency for the first intra-chiplet interconnect further comprises one or more signals and/or signal packets indicative of a specified future point in time at which the first chiplet is to adjust the clock frequency for the first intra-chiplet interconnect.

20. The apparatus of claim 19, wherein individual chiplets of the plurality of chiplets, including the first and second chiplets, are to adjust operating clock frequencies of respective intra-chiplet interconnects responsive at least in part to the signal and/or signal packet indicative of the intention by the first chiplet to adjust a clock frequency for the first intra-chiplet interconnect and further responsive to the one or more signals and/or signal packets indicative of the specified future point in time at which the first chiplet is to adjust the clock frequency for the first intra-chiplet interconnect.
